(19) United States
(12) Patent Application Publication
(10) Pub. No.: US 2006/0204238 A1
(43) Pub. Date: Sep. 14, 2006

(54) Camera, camera system, and control method for image data

(76) Inventor: Takeshi Suzuki, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/366,710

(22) Filed: Mar. 2, 2006

(30) Foreign Application Priority Data
Mar. 11, 2005 (JP) 2005-069709
Jan. 18, 2006 (JP) 2006-009518

(51) Int. Cl. G03B 17/24

(52) U.S. Cl. 396/310

(57) ABSTRACT

According to the present invention, a camera capable of transmitting image data from a recording medium to an external device to store the image data in the external device does not erase predetermined image data from the recording medium even after transmitting the image data to the external device. For example, the predetermined image data include, but not limited to, image data in which an error has occurred during storage into the external device, stored image data programmed for printing, stored image data programmed for distribution, image data registered in an album (that is, image data set in a group together with other image data), and image data protected (that is, image data with attribute information for prohibiting erasing of the image data).

### CROSS-REFERENCE TO RELATED APPLICATION

This application is based upon and claims the benefit of priority from prior Japanese Patent Application Nos. 2005-069709, filed on Mar. 11, 2005; and 2006-009518, filed on Jan. 18, 2006, the entire contents of which are incorporated herein by reference.

### BACKGROUND OF THE INVENTION

1. Field of the Invention

This invention relates to control technology for cameras having a function for erasing transmitted image data from a storage medium. The destination of the image data is, for example, a data storage unit externally connected. The storage medium is, for example, a storage medium incorporated in or removably loaded into the camera.

2. Description of the Related Art

Digital cameras using semiconductor devices such as CCDs (Charge Coupled Devices) to capture subject images have recently become widespread. Image data of images captured with cameras of this type are stored in an internal memory or on a recording medium inserted in a slot. The internal memory and the recording medium have a limited memory capacity, respectively. For this reason, image data are generally transferred and stored appropriately in mass storage media, such as an HDD, a DVD (Digital Versatile Disc) and a CD (Compact Disc), and then erased from the internal memory or removable recording medium.

Under the circumstances, a camera system composed of a camera and a dedicated station unit incorporating a large-capacity HDD and used by docking the camera therewith is proposed (for example, see Japanese Patent Laid-Open No. 2000-312325). In this camera system, when image data of shot images are transferred from the camera to the station unit, the amount of memory space remaining on the storage medium on the camera side is checked, and according to the amount of remaining memory space, an indication is given to urge a user to erase image data from the storage medium on the camera side.

A camera used in this type of camera system is also proposed, in which image data of a shot image is erased after confirming a flag indicating the completion of transfer to an external device so that the image data will not be erased by accident (for example, see Japanese Patent Laid-Open No. 2002-326404).

However, in a camera connected to a device for backing up image data, when a function for automatically erasing the backed-up image data from the storage medium on the camera side is activated, due consideration must be given to the conditions and timing. Otherwise, even image data that should be left on the storage medium on the camera side could be erased by accident. Although the function for automatically erasing backed-up image data from the storage medium on the camera side is indeed convenient, the user may feel more inconvenient than convenient when image data are always erased automatically.

### BRIEF SUMMARY OF THE INVENTION

A camera according to the present invention is capable of transmitting image data from a recording medium to an external device to store the image data in the external device. The camera does not erase predetermined image data even after transmitting the image data to the external device. For example, the predetermined image data include, but not limited to, image data in which an error has occurred during storage into the external device, stored image data programmed for printing, stored image data programmed for distribution, image data registered in an album (that is, image data set in a group together with other image data), and image data protected (that is, image data with attribute information for prohibiting erasing of the image data).

These predetermined image data are not erased after being transmitted to the external device as being left on the camera side. On the other hand, among the image data transmitted to the external device, all but the predetermined image data are automatically erased. Upon this automatic erasing, it can be configured such that the camera asks a user to confirm whether to erase the image data. In this case, the camera performs the automatic erasing of image data only when confirming from user's operations that the image data should be erased.

This is effective in preventing accidental erasing of image data that should be left on the camera side after being transmitted to the external device.

As an exemplary structure, a camera of the present invention comprises: a data communication part for communicating with an external device to transmit image data to the external device; a data storage part for instructing the data communication part to transmit and store, into the external device, image data stored on a recording medium incorporated in or removably loaded into the camera; and a data control part for performing control operations related to the image data stored on the recording medium. In this structure, when erasing, from the recording medium, the image data transmitted through the data storage part to the external device, the data control part performs control not to erase image data for which a predetermined setting is made.

When the image data corresponds to at least one of image data programmed for printing, image data registered in a specific group, and image data programmed for distribution to a network, it can be configured that the data control part determines that the predetermined setting is made for the image data, and perform control not to erase the image data from the recording medium.

It also can be configured such that the data control part also erases, from the recording medium, image data transmitted to the external device through the data storage part after confirming that the transmitted image data has been stored in the external device.

The camera can also comprise a print instruction part for instructing the data communication part to transmit, to an external printer, only image data programmed to be printed from all image data stored on the recording medium so that the image data transmitted will be printed on the printer. In this case, the image data programmed for printing is not erased even after being stored in the external device. In other words, after completion of storage into the external device through the data storage part and printing on the printer through the print instruction part, the data control part cancels the printing program and erases the image data from the recording medium.

The camera can further comprise a data distribution part for instructing the data communication part to transmit, to a network, image data stored on the recording medium and programmed for distribution as one of the predetermined settings so that the image data transmitted will be distributed to a remote device(s). In this case, the image data programmed for distribution is not erased even after being stored in the external device. In other words, after completion of storage into the external device through the data storage part and distribution to the network through the data distribution part, the data control part cancels the distribution program and erases the image data from the recording medium.

Further, when a recording medium of the external device on which image data is to be stored requires finalization, the camera can erase the image data after confirming the completion of finalization in the external device.

The present invention can also be understood as a camera system including the above-mentioned camera, a first external device for storing image data transmitted from the camera, and a second external device for printing an image(s) of image data transmitted from the camera.

The present invention can further be understood as a camera control method for transmitting image data to an external device through a data communication part and storing the image data in the external device. In this case, the method can be configured to instruct the data communication part to transmit, to the external device, the image data stored on a recording medium incorporated in or removably loaded into the camera, and store the image data in the external device, so that, when erasing the stored data from the recording medium, image data corresponding to at least one of image data programmed for printing, image data programmed for distribution, and image data registered in a specific group is not erased from the recording medium even after being stored in the external device.

Furthermore, the present invention can be understood as a computer-readable recording medium recording a program for causing a computer to execute the above-mentioned control method.

According to the present invention, a camera, a camera system, and a control method for image data can be provided, which are effective in preventing accidental erasing of image data that should be left on the camera side after being transmitted to the external device.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1A is a font view of a digital camera according to one preferred embodiment of the present invention;

FIG. 1B is a side view of the digital camera according to the embodiment of the present invention;

FIG. 1C is a top view of the digital camera according to the embodiment of the present invention;

FIG. 2A is a front view of the camera according to the embodiment of the present invention when a display unit is rotated downward;

FIG. 2B is a side view of the camera according to the embodiment of the present invention when the display unit is rotated downward;

FIG. 3A is a first illustration for explaining how to use the camera according to the embodiment of the present invention;

FIG. 3B is a second illustration for explaining how to use the camera according to the embodiment of the present invention;

FIG. 4 is a perspective view of a stand unit to which the camera can be removably attached according to the embodiment of the present invention;

FIGS. 5A and 5B are perspective views for explaining two ways of attaching the camera to the stand unit according to the embodiment of the present invention;

FIG. 6 is a perspective view showing such a state that the camera 1 is connected to a data storage unit and a printer through the stand unit according to the embodiment of the present invention;

FIG. 7 is a block diagram showing a camera system composed of the camera, the stand unit, the data storage unit, and the printer, connected to each other according to the embodiment of the present invention;

FIG. 8 is a block diagram showing the structure of the camera according to the embodiment of the present invention;

FIG. 9 is a flowchart showing the first half of a basic procedure for automatic erasing of stored image data according to the embodiment of the present invention;

FIG. 10 is a flowchart showing the second half of the basic procedure for automatic erasing of stored image data according to the embodiment of the present invention;

FIG. 11 is a flowchart showing a procedure for automatic erasing of stored image data when printing is performed continuously after the storage operation;

FIG. 12 is a flowchart showing the first half of a procedure for automatic erasing of stored image data when a recording medium requiring finalization is a storage destination according to the embodiment of the present invention; and

FIG. 13 is a flowchart showing the second half of the procedure for automatic erasing of stored image data when the recording medium requiring finalization is the storage destination according to the embodiment of the present invention.

### DETAILED DESCRIPTION OF THE PREFERRED EMBODIMENT

A preferred embodiment of the invention is described below with reference to the accompanying drawings.

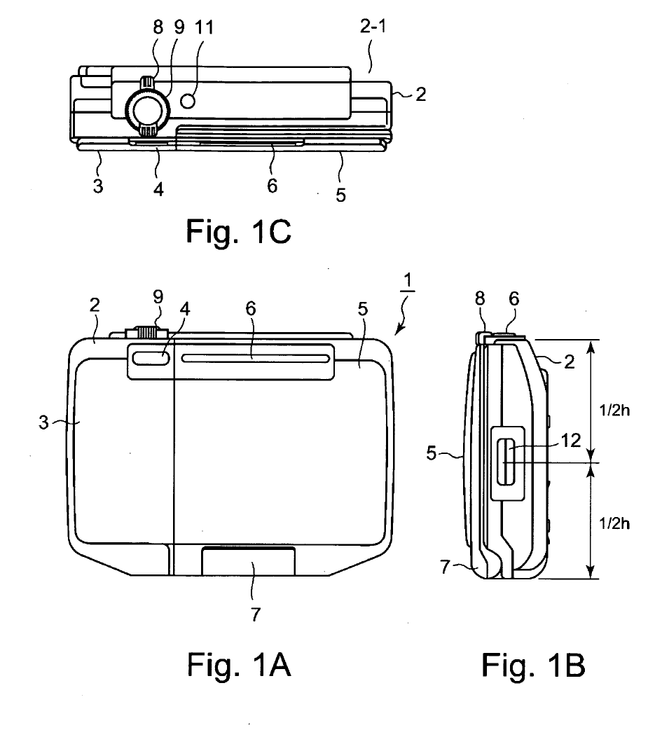

FIGS. 1A to 1C are outline views of a digital camera 1 according to one preferred embodiment of the present invention. FIG. 1A is a front view. FIG. 1B is a side view on the side of a connection part provided. FIG. 1 C is a top view. FIGS. 1A to 1C show a state of the camera 1 when a display unit is folded in a closed position.

As shown in FIGS. 1A to 1C, the camera 1 has a holding part 3 formed in an area about one-third of (the width of) a camera body 2 from the left in the front view of FIG. 1A. A self-timer indicator window 4 is provided in the upper part of the holding part 3. Then, the back face of a display unit 5 covers about two-third of (the width of) the camera body 2 from the right in the front view of the camera. An indicator lamp window 6 is provided above the display unit 5 so that the lamp lights up or blinks to indicate various camera states. A double hinge 7 is provided below the display unit 5. Further, as shown in the top view of FIG. 1C, a step 2-1 is formed at the backside end of the camera body 2 opposite to the display unit 5.

On the top face of the camera 1, a zoom lever 8 and a shutter-release button 9 are arranged above the self-timer indicator window 4. A remote control light-receiving part 11 is provided on the right side of the shutter-release button 9. Further, as shown in the side view of FIG. 1B, a camera connection part 12 is provided in the camera 1. The camera connection part 12 is positioned at the center of the height of the camera 1 (one-half of h where h is the height of the camera). This prevents the camera connection part 12 from changing its position even when the camera 1 is upside down.

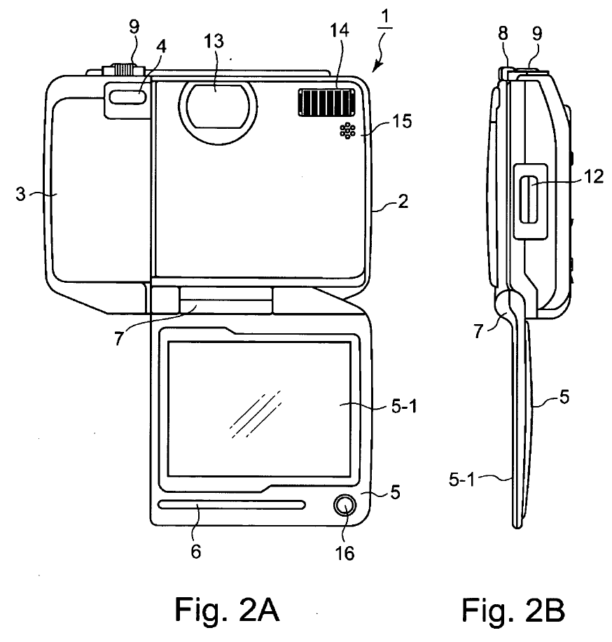

FIGS. 2A and 2B are outline views of the camera 1 when the display unit 5 is rotated downward to an open position. FIG. 2A is a front view. FIG. 2B is a side view on the side of the connection part provided.

As shown in the front view of FIG. 2A, when the display unit 5 is pivoted downward on the double hinge 7, the camera body 2 is opened and its front face appears. A taking lens window 13 is arranged on the upper left side of the front face (about at the center of the width of the camera), an electronic flash window 14 is arranged at the upper right end, and a microphone 15 is arranged below the electronic flash window 14. Further, a liquid crystal display (LCD) monitor is provided inside the display unit 5, and an LCD screen 5-1 is arranged on the front face of the display unit 5.

A power button 16 is provided on the lower right side of the LCD screen 5-1 of the display unit 5. Note that the indicator lamp lights up or blinks through the indicator lamp window 6 regardless of whether the display unit 5 is folded as shown in FIG. 1A or it is open as shown in FIG. 2A. In other words, the indicator lamp lights up or blinks through both the front and back of the display unit 5.

In the open state of the display unit 5 shown in FIG. 2, the camera 1 is used to shoot the user himself or herself while viewing the LCD monitor screen 5-1.

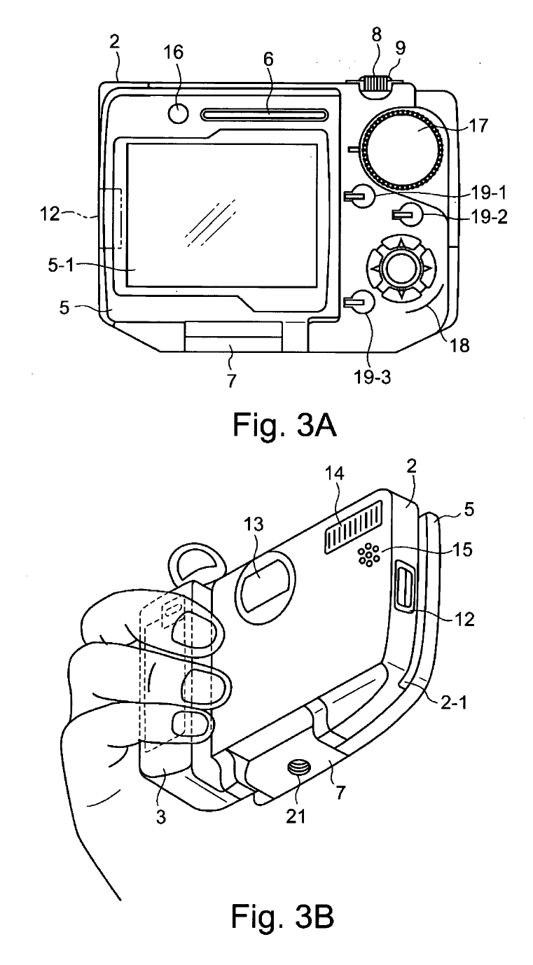

FIGS. 3A and 3B show how to use the camera 1. FIG. 3A is a back view showing such a state that the display unit 5 is rotated further from the downward position to a position where the display unit 5 comes to the backside of the camera 1 so that the back face of the display unit 5 will come in contact with the back face of the camera body 2. FIG. 3B is a perspective view when the user is holding the camera 1. Portions common to those in FIGS. 1A to 1C and FIGS. 2A and 2B are given the same reference numbers.

FIG. 3A shows a state at the time of using the camera 1, in which the display unit 5 is on the backside of the camera 1 to position the LCD screen 5-1 on the back face of the camera 1 so that it will cover about two-third of the back face of the camera 1. In this state, a mode dial 17, an XY control button 18, and the other operation buttons 19 (19-1, 19-2, 19-3) lie on the remaining one-third of the back face of the camera 1. This allows the user or operator to perform various operations while viewing display images on the LCD screen 5-1 of the display unit 5.

Upon shooting, the operator holds the holding part 3 as shown in FIG. 3B so that the operator can shoot an image at every press of the shutter-release button 9 while confirming a video picture on the LCD screen 5-1. Further, in this shooting state, since the display unit 5 is on the back of the camera 1, the double hinge 7 is also inside out, that is, the position of the double hinge 7 is changed from its carrying state shown in FIGS. 1A to 1C. Therefore, in the state of FIG. 3B, a tripod screw hole 21 formed on the back face of the double hinge 7 is exposed to the outside. This allows the operator to set the camera 1 on a tripod to shoot images.

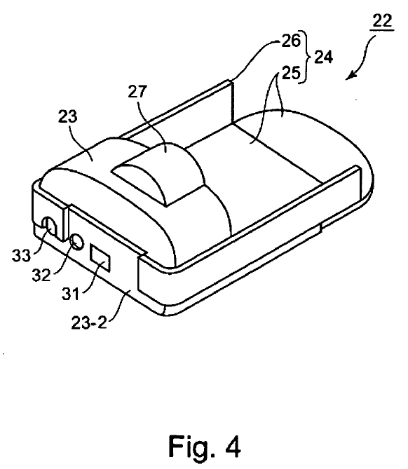

FIG. 4 is a perspective view of a stand unit 22 to which the camera 1 can be removably attached. As shown, the stand unit 22 has a stand body 23 and a housing part 24. The housing part 24 has a placing face 25 on which the camera 1 is placed, and sidewalls 26 rising from the opposite edges of the placing face 25. The sidewalls 26 protect and position both sides of the camera 1 in its height direction when the camera 1 is placed on the placing face 25.

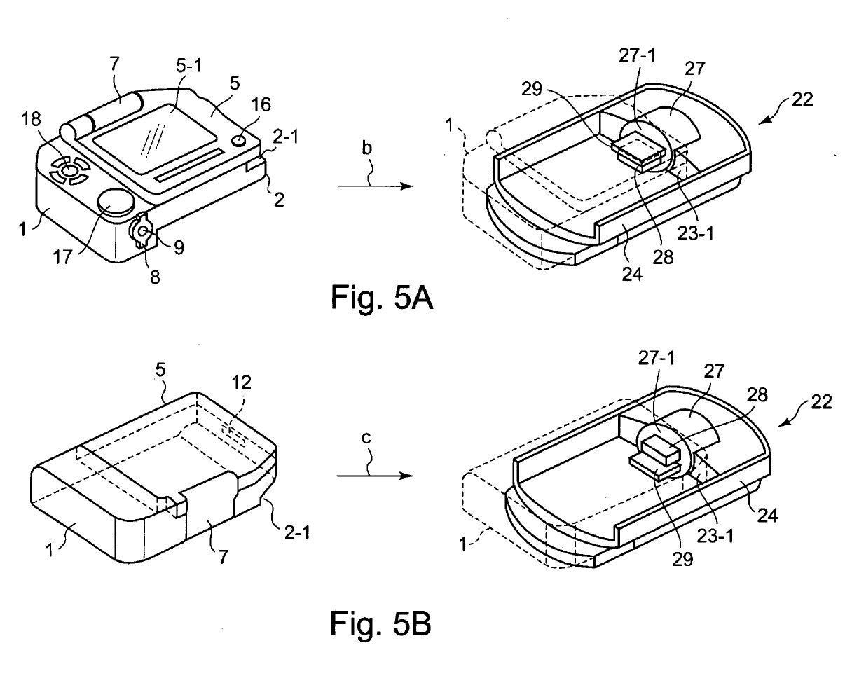

The stand body 23 has a cylindrical pivot part 27 formed in the center of a flat face portion (23-1 in FIG. 5 to be described later). The pivot part 27 has a cylindrical end face as a pivot face (27-1 in FIG. 5). The pivot face is so arranged that it will face the camera connection part 12 when the camera 1 is housed in the housing part 24. Further, the pivot part 27 is so arranged that part of the circumferential surface of its cylindrical shape used as an operation part will be exposed on the top of the stand body 23.

A stand connection part (28 in FIG. 5) projects from the pivot face of the pivot part 27 so that it will be electrically connected with the camera connection part 12 of the camera 1. The stand connection part is provided slightly off the pivot center on the pivot face of the pivot part 27 in its radial direction. The camera 1 can be housed in the housing part 24 regardless of whether the camera 1 is face up or down. In this case, the user can rotate the pivot part 27 to change the stand connection part 28 between two positions depending on the position of the camera connection part 12 changing with the direction in which the camera 1 is housed.

Further, a depressed portion 23-2 that is flat as a whole and is depressed from both side portions is formed on the back face of the stand body 23. In this depressed portion 23-2, a USB (Universal Serial Bus) connector 31, which allows the camera 1 to communicate with external devices, and a DC power connector 32 are provided. A video output terminal 33 is provided in a projection portion on the left of both sides surrounding the depressed portion 23-2.

FIGS. 5A and 5B are perspective views for explaining two ways of attaching the camera 1 to the stand unit 22 according to the embodiment of the present invention. The left view of FIG. 5A shows the camera 1 with the LCD screen 5-1 of the display unit 5 facing up. The right view of FIG. 5A shows the position of a connection limiting member 29 working with the stand connection part 28 when the camera 1 with the LCD screen 5-1 facing up is attached to the stand unit 22. On the other hand, the left view of FIG. 5B shows the camera 1 in the state shown in FIGS. 1A to 1C with its front facing up. The right view of FIG. 5B shows the position of the connection limiting member 29 working with the stand connection part 28 when the camera 1 with its front facing up is attached to the stand unit 22.

The following describes how the camera connection part 12 can be connected with the stand connection part 28 in a proper combination of the direction of the camera 1 and the pivot position of the pivot part 27. In this case, the position of the camera connection part 12 relative to the height of the camera 1 does not change regardless of whether the camera 1 faces up or down when it is placed in the housing part 24 of the stand unit 22. In other words, even if the camera 1 facing down as shown in FIG. 5A is attached to the stand unit 22 as shown in FIG. 5B, the position between the camera connection part 12 and the camera 1 does not change.

Therefore, the camera connection part 12 of the camera 1 can be connected with the stand connection part 28 regardless of whether the camera 1 faces up or down only by rotating the pivot part 27 180 degrees to change the position of the stand connection part 28 provided on the pivot face 27-1.

In this case, however, they can be mechanically connected even if they are connected in a reverse way. In such a reverse connection, normal operation cannot be expected, and besides, it could cause a failure. To prevent the reverse connection, the connection limiting member 29 having a plate-like shape is provided on the pivot face 27-1 of the pivot part 27 to prevent the reverse connection. The connection limiting member 29 is so provided that it projects more than the stand connection part.

The connection limiting member 29 enters the step 2-1 only in the proper combination to allow the camera connection part 12 to be connected with the stand connection part 28. On the contrary, in the wrong combination, the connection limiting member 29 strikes the side of the camera 1 before the camera connection part 12 is connected with the stand connection part 28 to disable the connection between the camera connection part 12 and the stand connection part 28.

The left view of FIG. 5A shows the camera 1 with the LCD screen 5-1 of the display unit 5 facing up. The right view of FIG. 5A shows such a state that the camera 1 with the LCD screen 5-1 facing up is attached to the stand unit. As shown, when the upside-down camera 1 is attached to the stand unit 22 in the direction of b, the operator can view a display image on the LCD screen 5-1 of the display unit 5 even when the camera 1 is being recharged from the DC power supply through the DC power connector 32. Therefore, the operator can operate the mode dial 17, the XY control button 18, and the other operation buttons 19-1 to 19-3 while viewing the display image.

On the other hand, the left view of FIG. 5B shows the camera 1 with its front facing up as shown in FIG. 1. The right view of FIG. 5B shows such a state that the camera 1 with its front facing up is attached to the stand unit 22. In the right view of FIG. 5B, the pivot part 27 is rotated 180 degrees from the state shown in the right view of FIG. 5A.

In this state, the camera 1 is moved in a direction indicated by arrow C to the housing part 24 of the stand unit 22 so that the camera 1 will be attached to the stand unit 22 as indicated by the broken line. In this case, the tip of the connection limiting member 29 also enters the step portion 2-1 of the camera body 2, while the stand connection part 28 is connected with the camera connection part 12, though the operator cannot operate the mode dial 17 and the XY control button 18 in this state.

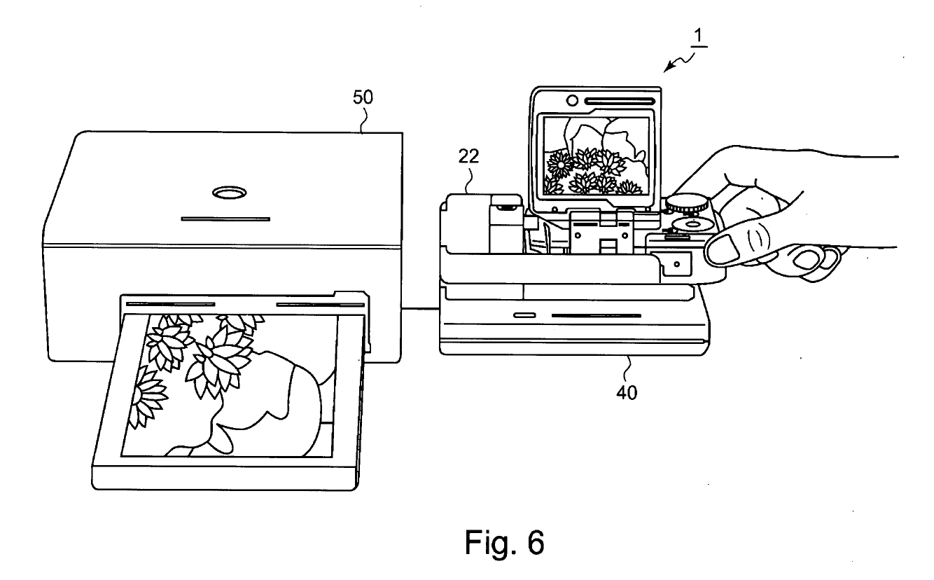

FIG. 6 is a perspective view showing such a state that the camera 1 is connected to a data storage unit 40 as a first external device and a printer 50 as a second external device through the stand unit 22. The stand unit 22 also has a connection part (not shown) for electrically connecting it to the connection part of the data storage unit 40 when the stand unit 22 is mounted right on the top face of the data storage unit 40. The connection part is electrically connected with the stand connection part 28 mentioned above. In other words, the camera 1 can be electrically connected to the data storage unit 40 by attaching the camera 1 to the stand unit 22 mounted on the data storage unit 40. Further, the camera 1 can be electrically connected to the printer 50 by connecting the data storage unit 40 to the printer 50 through a cable.

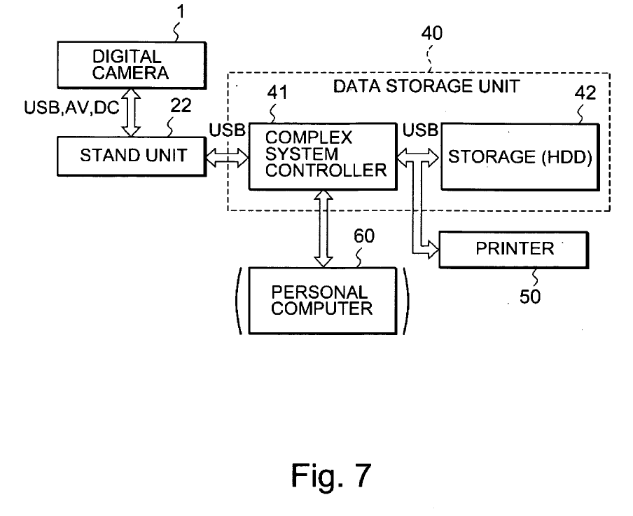

FIG. 7 is a schematic block diagram showing the system structure of a camera system according to the embodiment of the present invention. The camera system is composed of the camera 1, the stand unit 22, the data storage unit 40, the printer 50, a network 71, a remote device(s) 72, etc, all of which are connected to each other as shown in FIG. 6. As shown, the camera 1 is electrically connected to the data storage unit 40 through the stand unit 22, and to the printer 50 through the data storage unit 40. The connection is made through a USB cable, forming a tree structure having the camera 1 as a host and the data storage unit 40 and the printer 50 as devices. Therefore, in the camera system, the communication between the camera 1 and the data storage unit 40 and the communication between the camera 1 and the printer 50 are exclusively selected.

The data storage unit 40 can also be connected to a personal computer 60 as well as the data storage unit 40 and the printer 50. As mentioned above, since the stand unit 22 has the USB connector 31, the user can connect the personal computer 60 directly to the camera 1 via the stand unit 22. Alternatively, as shown in FIG. 7, the personal computer 60 can be connected via the data storage unit 40 as one device in the tree structure having the camera 1 as its center. The same is true for the printer 50. The user can connect the printer 50 in two ways, that is, the user can also connect the printer 50 directly to the camera 1 via the stand unit 22. The data storage unit 40 includes a complex system controller 41 for controlling the entire operation as a hub constituting a bus on the tree structure having the camera 1 as its center, and a storage part 42 for storing image data of images shot with the camera 1.

The stand unit 22 or the data storage unit 40 can also be connected to the network 71. In this case, the stand unit 22 or the data storage unit 40 is connected to a router 70 via the USB port. The router 70 is a device for relaying data flowing through the network to another network. The router 70 is connected to the network 71. A typical example of the network 71 is a telephone line. Then, remote devices 72 (e.g., cellular phone, personal computer, printer, etc.) are connected to the network 71. In operation, image data read from a recording medium 115 is distributed to the remote devices 72 through a provider's server (not shown) provided on the network 71.

Thus, the camera 1 can be easily connected to the data storage unit 40, the printer 50, the network 71, the personal computer 60, etc. merely by attaching the camera 1 to the stand unit 22 mounted on the data storage unit 40. Therefore, the camera 1 has various modes of operation, as well as shooting and charging a battery 126, such as a storage mode for transmitting image data to the data storage unit 40 and instructing the data storage unit 40 to store the image data, a print mode for transmitting image data to the printer 50 and instructing the printer 50 to print the image data, a PC mode for communication with the personal computer 60, and a distribution mode for distributing image data to the remote devices 72 connected on the network 71. The camera 1 also has an automatic erasing function which, after storing image data in the storage mode, automatically erases the image data from the recording medium 115.

The present invention features that, when automatically erasing stored image data, the camera 1 controls not to accidentally erase image data that should be left on the recording medium 115. The following describes this point.

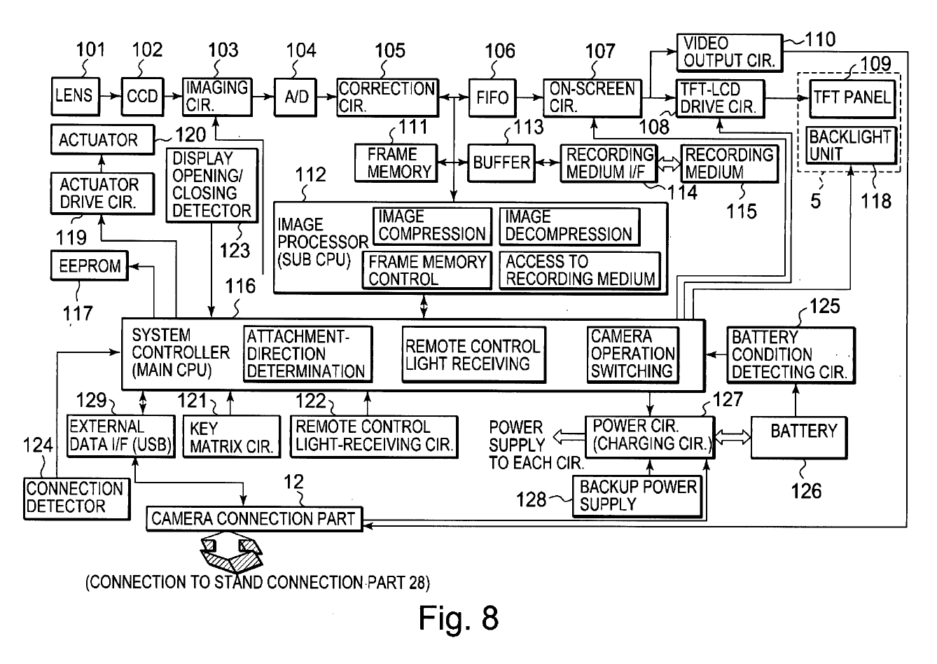

Referring first to FIG. 8, the structure of the camera 1 is described. FIG. 8 is a block diagram showing the structure of the camera 1.

When light of a subject image passing through the lens 101 is incident on a CCD (Charge Coupled Device) 102, the subject image is formed on the imaging surface. An imaging circuit 103 performs various control operations on the CCD 102, such as exposure control and reading control. A picture signal from the CCD 102 read by the imaging circuit 103 is converted by an A/D conversion circuit 104 from an analog signal to a digital signal, and input into a correction circuit 105.

The correction circuit 105 performs various correction processing on the input picture signal, such as the setting of ISO-equivalent sensitivity, automatic white balance processing, luminance/color signal creation, and gamma processing, to generate a color picture signal in a predetermined format. The color picture signal is transferred to an on-screen circuit 107 through a FIFO (First-In, First-Out) memory 106. In the on-screen circuit 107, icons or indicators, which indicate information to be presented to the user, such as the settings or shooting conditions of the camera 1 including the number of shootable frames, are superimposed on the color picture signal. The color picture signal output from the on-screen circuit 107 is supplied to a TFT (Thin Film Transistor) LCD drive circuit 108 and displayed on a TFT panel 109 of the display unit 5 as a monitor image. Alternatively, the color picture signal output from the on-screen circuit 107 is supplied to a video output circuit 110 and output to the outside.

On the other hand, the color picture signal output from the correction circuit 105 is also captured into a frame memory 111 at every press of the shutter-release button 9. The color picture signal captured in the frame memory 111 is compressed and encoded by an image processor 112, stored in a recording buffer 113, and recorded as a shot image on the recording medium 115 such as a card-type memory device through a recording medium I/F 114. The shot image recorded on the recording medium 115 is read by the image processor 112 upon playback. The read picture image is decompressed and decoded, and stored in the frame memory 111. After stored in the frame memory 111, the picture image is displayed on the TFT panel 109 of the display unit 5 via the FIFO memory 106, the on-screen circuit 107, and the TFT-LCD drive circuit 108 in the same manner as the monitor image upon shooting. Alternatively, the picture image is output to the outside via the video output circuit 110. The image processor 112 performs control of the frame memory 111 as well as compression and encoding (image compression function), decompression and decoding (image decompression function), and access control to the recording medium 115 (access function to the recording medium) as mentioned above.

The operation of the camera 1 as described above is integrally controlled by a system controller 116. A program describing the control procedure performed by the system controller and various setting values as parameters to be passed on the program are stored in an EEPROM 117. The imaging circuit 103, the on-screen circuit 107, the TFT-LCD drive circuit 108, the image processor 112, and a backlight unit 118 of the display unit 5 receive respective control signals directly from the system controller 116 so that they will be driven under the control of the system controller 116. An actuator 120 is driven by an actuator drive circuit 119 that also receives a control signal from the system controller 116. The lens 101 is driven by the actuator 120.

To the system controller 116, control signals are supplied from a key matrix circuit 121, a remote control light-receiving circuit 122, a display unit opening/closing detector 123, a connection detector 124, and a battery condition detecting circuit 125. The key matrix circuit 121 detects the operations of the zoom lever 8, the shutter-release button 9, etc. and notifies the system controller 116 of the operations. The remote control light-receiving circuit 122 detects that the remote control light-receiving part 11 has received light of a remote control signal, and notifies the system controller 116 of it. The display unit opening/closing detector 123 detects whether the camera 1 is in a closed state, that is, whether the display unit 5 is folded as shown in FIG. 1, and notifies the system controller 116 of the closing state of the display unit 5. The connection detector 124 detects whether the camera 1 is in a state of either shown in FIG. 5A or 5B, that is, whether the camera 1 is attached to the stand unit 22 with either its front or back side down, and notifies the system controller 116 of the attachment. The battery condition detecting circuit 125 monitors the rechargeable battery 126 to detect a battery condition such as a low-battery condition, and notifies the system controller 116 of the battery condition. A power supply circuit 127 controls power supply to the camera 1 including recharging of the battery 126. The system controller 116 also supplies a control signal to the power supply circuit 127 to control the drive of each component. In addition to the battery 126, the camera 1 is also equipped with a backup power supply 128 such as a button-shaped battery.

Further, an external data I/F 129 as a data communication part is connected to the system controller 116. The external data I/F 129 allows the camera 1 to exchange data with the data storage unit 40, the printer 50, and/or the network 71 connected to the camera 1 through the camera connection part 12.

The system controller 116 has a data storage part 116b, a print instruction part 116c, and a data distribution part 116d as functions related to the above-mentioned transmission of stored image data. The data storage part 116b transmits image data recorded on the recording medium 115 to the data storage unit 40, and instructs the data storage unit 40 to store the image data. The print instruction part 116c transmits image data recorded on the recording medium 115 to the printer 50, and instructs the printer 50 to print the image data. The data distribution part 116d instructs the distribution of image data recorded on the recording medium 115 to the remote devices 72 via the router 70 and the network 71.

The image data read from the recording medium 115 in accordance with the instruction of the data distribution part 116d is transmitted from the external data I/F 129 and distributed to the remote devices 72 (cellular phone, personal computer, printer, etc.) via the router 70 through a provider's server provided on the network 71. The data distribution part 116d also manages a distribution program with plural pieces of image data prestored for distribution.

The system controller 116 also has a data control part 116a as a function related to automatic erasing of transmitted, stored image data. In addition to the above-mentioned function, the data control part 116a has various other functions such as a printing error determination function, a storage error determination function, an image erasing function, a printing program function, an album function, and an image protection function. The functions of the data control part 116a are part of functions executed by the system controller 116 according to the program.

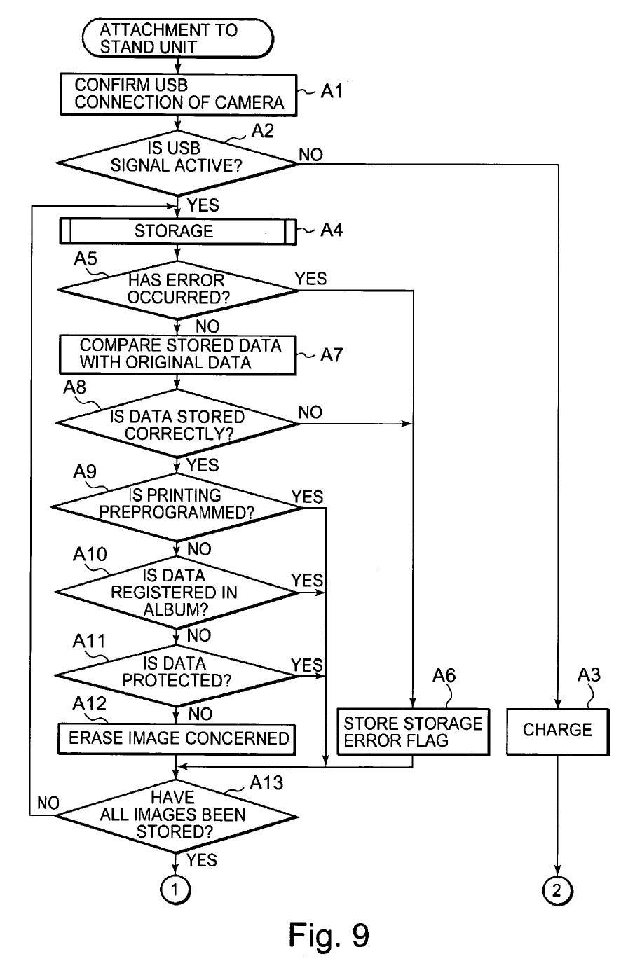

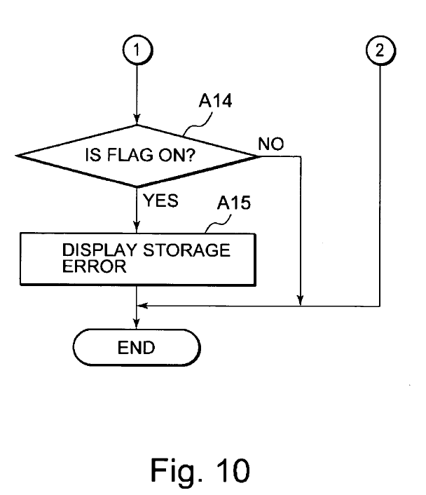

Referring to the flowcharts of FIGS. 9 and 10, a basic procedure for storing image data and automatically erasing the stored image data are first described.

When the attachment of the camera 1 to the stand unit 22 is detected by the control signal from the connection detector 124, the system controller 116 queries the external data I/F 129 for the USB connection state (step A1). If the USB signal is not active (NO in step A2), the system controller 116 instructs the power supply circuit 127 to charge the battery 126 (step A3). On the other hand, if the USB signal is active (YES in step A2), the system controller 116 determines that the data storage unit 40 is connected, and performs the storage of image data (step A4). In the storage operation, the system controller 116 instructs the recording medium I/F 114 to read image data from the recording medium 115, so that the data storage part 116b instructs the external data I/F 129 to transmit the read image data to the data storage unit 40.

In the storage operation, if the occurrence of an error is notified from the data storage unit 40 to the external data I/F 129 (YES in step A5), the system controller 116 stores in the EEPROM 117 a storage error flag indicating that an error has occurred during the storage operation (step A6). On the other hand, if the storage operation is completed normally (No in step A5), the system controller 116 compares the stored image data with the original image data (step A7). As a result of the comparison, if any different is found (NO in step A8), the system controller 116 also stores in the EEPROM 117 the storage error flag indicating that an error has occurred during the storage operation (step A6).

On the other hand, if the comparison shows that the image data is stored correctly (YES in step A8), then the data control part 116a checks the presence or absence of a printing program, a distribution program, the setting of album registration, and the setting of protection for the image data (steps A9, A10, and A11).

The printing program is to reserve, from all image data stored on the recording medium 115, only image data the user wants to print on the printer 50. This printing program function allows the user to print only the image data of target images by one operation.

The distribution program is to reverse, from all image data stored on the recording medium 115, only image data the user wants to distribute to the remote devices 72. This distribution program function allows the user to distribute only the target image data by one operation.

The album registration is to register, from all image data stored on the recording medium 115, only image data the user wants to manage in one group. The album registration function allows the user to handle only image data in a target group for playback or printing as a single unit.

Further, the protection is to protect, from all image data stored on the recording medium 115, only image data the user specifies not to erase. The image protection function can prevent the user from erasing important image data due to user's wrong operation.

The settings of these programs and the like are displayed on the TFT panel 109 as dedicated setting screens, respectively, so that they are made effective by the system controller 116 according to the control signals from the key matrix circuit 121 that detects user's key operations on the setting screens, respectively. The contents of the key operations are stored, for example, in predetermined folders on the recording medium 115 as printing program information, distribution program information, album registration information, and protection information, respectively. In other words, the data control part 116a refers to these pieces of information so that it can determine the presence or absence of the settings of the printing program, the distribution program, the album registration, and the protection.

Then, if none of the printing program, distribution program, album registration, and protection is set for the image data concerned (No in steps A9, A10, and A11), the data control part 116a instructs the recording medium I/F 114 to erase the image data from the recording medium 115 (step A12). The term “erase” means not only to delete the data from the recording medium 115, but also to update a management file for the recording medium 115 to permit overwriting of the data with another data or writing of another data over the data area concerned.

On the other hand, when at leas one of the printing program, distribution program, album registration, and protection is set (YES in step A9, A10, or A11), the data control part 116a leaves corresponding image data intact on the recording medium 115 after being stored in the data storage unit 40.

The system controller 116 (the data control part 116a and the data storage part 116b) executes steps A4 to A12 for all image data on the recording medium 115. Then, when completing the steps for all image data (YES in step A13), the system controller 116 checks if any storage error flag is held in the EEPROM 117 (step A14). If any storage error flag is held (YES in step A14), the system controller 116 controls the image processor 112, the on-screen circuit 107, and the TFT-LCD drive circuit 108 to display on the TFT panel 109 a message indicating that an error has occurred during the storage operation (step A15).

Thus, at the time of automatically erasing stored image data, control is made in the camera 1 about the image data for which a predetermined setting(s) is made and considered that it would be better left in the camera 1, prohibiting the image data from being erased.

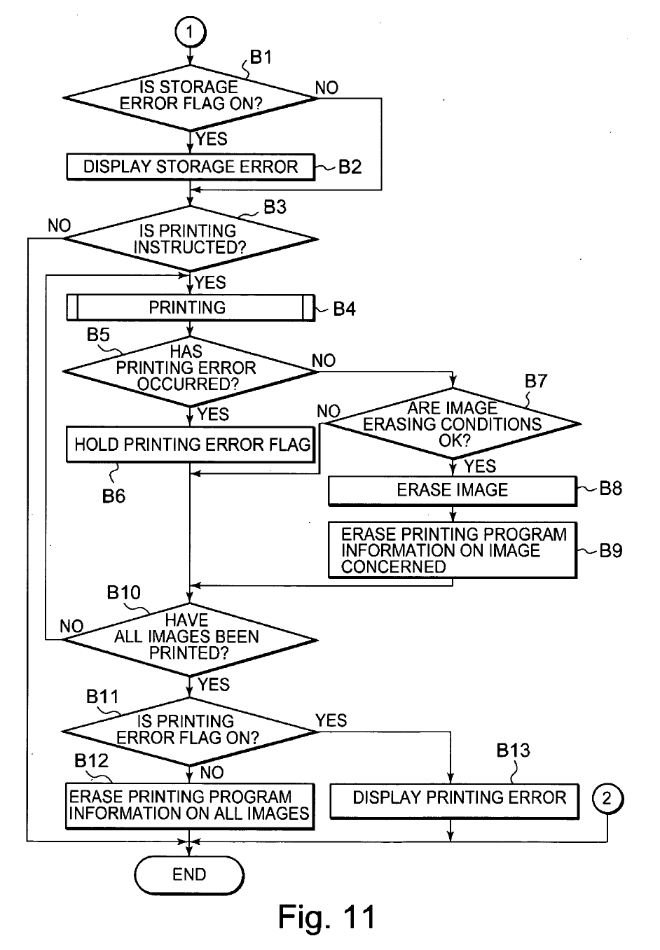

The camera 1 can also be set so that, after the completion of the storage mode, it will continuously perform the print mode for printing the image data programmed to be printed from all image data stored on the recording medium 115. In other words, if the camera 1 is set this way, the user can not only store image data of shot images by one operation (storage mode), but also print the preselected image data (print mode), merely by attaching the camera 1 to the stand unit 22 mounted on the data storage unit 40. Referring next to the flowchart of FIG. 11, a procedure for automatically erasing stored image data in consideration with this setting of the camera 1 is described.

The flow of operations from when the camera 1 is attached to the stand unit 22 until completion of the storage operation is the same as the flow shown in FIG. 9. In this case, the procedure proceeds from step A13 in FIG. 9 to step B1 in FIG. 11. Then, when a storage error flag is held in the EEPROM 117 (YES in step B1), the message is displayed on the TFT panel 109 (step B2). Then, the system controller 116 checks whether the camera 1 is set to execute the print mode (step B3). This setting is displayed on a dedicated setting screen so that it will be made effective by the system controller 116 according to the control signal from the key matrix circuit 121 that detects user's operation on the setting screen. Since the setting content is held in the EEPROM 117, the system controller 116 refers to the EEPROM 117 to determine the presence or absence of the setting.

If the setting indicates continuous shifting to the print mode (YES in step B3), the system controller 116 instructs the recording medium I/F 114 to read image data programmed to be printed from all image data stored on the recording medium 115. Then, the print instruction part 116c instructs the external data I/F 129 to transmit the read image data to the printer 50 for printing operation (step B4).

In the printing operation, if the occurrence of an error is notified from the printer 50 to the external data I/F 129 (YES in step B5), the system controller 116 stores in the EEPROM 117 a printing error flag indicating the occurrence of an error during the printing operation (step B6). On the other hand, if the printing operation is completed without occurrence of any error (NO in step B5), the data control part 116a checks the presence or absence of the settings other than the printing program, that is, the distribution program, the setting of album registration, and the setting of protection (step B7). If there is no other setting (YES in step B7), the data control part 116a determines that the printed image data is erasable. Therefore, the data control part 116a instructs the recording medium I/F 114 to perform automatic erasing of the stored image data at this timing (step B8). Then, the data control part 116a erases the printing program for the image data (step B9). The printing program information and the image data can be erased in opposite order.

The system controller 116 (the data control part 116a and the print instruction part 116b) executes steps B4 to B9 for all image data programmed to be printed from all the image data on the recording medium 115. If completing the steps for all image data programmed (YES in step B10), the system controller 116 checks if any printing error flag is held in the EEPROM 117 (step B11). If no printing error flag is held (NO in step B11), the data control part 116a erases the entire contents of the printing program information from the recording medium 115 (step B12). On the other hand, if any printing error is held in the EEPROM 117 (YES in step B11), the system controller 116 controls the image processor 112, the on-screen circuit 107, and the TFT-LCD drive circuit 108 to display on the TFT panel 109 a message indicating that an error has occurred during the printing operation (step B13).

Thus, at the time of automatically erasing stored image data, proper control is made in the camera 1 about the image data programmed to be printed, erasing the image data after the completion of the printing operation. In other words, if there is no other setting for the image data, such as the distribution program, the printed image data already transmitted from the recording medium 115 and stored in the data storage unit 40 are all erased from the recording medium 115.

Further, the camera 1 can perform distribution processing on image data stored on the recording medium 115 and programmed for distribution after completion of the storage mode. Since this procedure can be implemented by replacing the print processing described in FIG. 11 with distribution processing, a flowchart of the distribution processing is omitted. If the camera 1 is set this way, the user can not only store image data of shot images by one operation (storage mode), but also distribute the preselected image data (distribution mode), merely by attaching the camera 1 to the stand unit 22 mounted on the data storage unit 40. Then, the data control part 116a clears the distribution program after completion of the storage and distribution of image data and automatically erases the image data in the same manner as in the printing operation of FIG. 11.

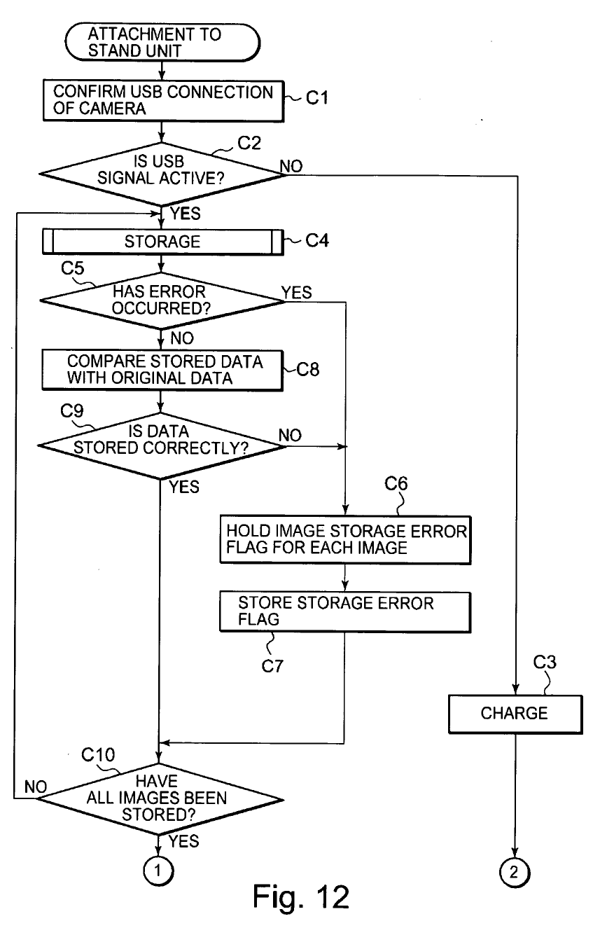

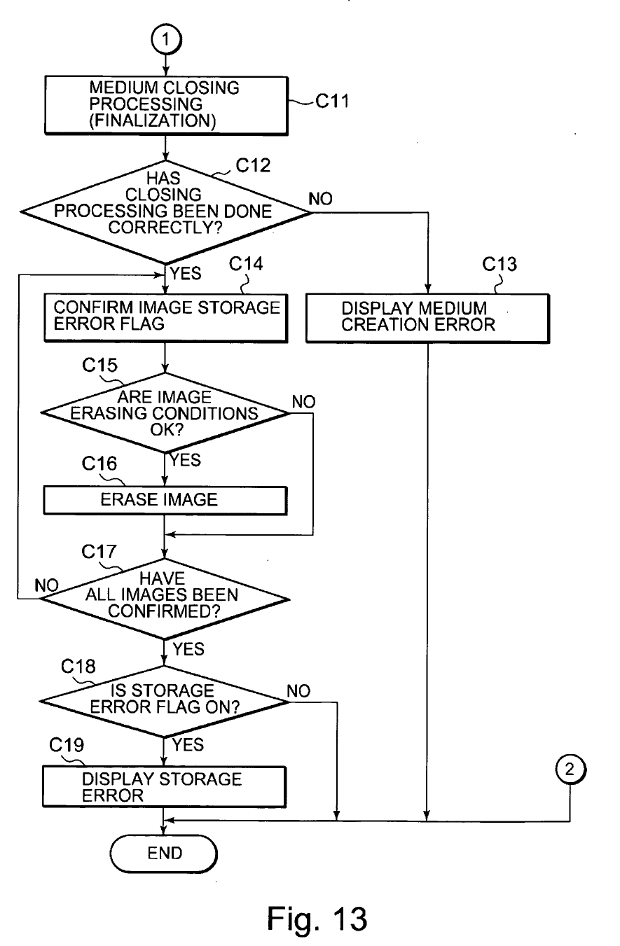

The above description is made on condition that the data storage unit 40 incorporating an HDD as the storage 42 is the storage destination of image data. However, a CD-R or DVD is often used as the storage destination. In the case of the CD-R or DVD, in order to ensure compatibility between drive units manufactured by and distributed from different companies, closing processing called finalization is performed after writing of data to the CD-R or DVD. If the finalization is not done normally, there is a case where data cannot be read even if individual pieces of data have been written normally. The following describes a procedure for automatically erasing stored image data from the recording medium 115 when a recording medium requiring the finalization process is the storage destination with reference to the flowcharts of FIGS. 12 and 13.

When the attachment of the camera 1 to the stand unit 22 is detected by the control signal from the connection detector 124, the system controller 116 first queries the external data I/F 129 for the USB connection state (step C1). If the USB signal is not active (NO in step C2), the system controller 116 instructs the power supply circuit 127 to charge the battery 126 (step C3). On the other hand, if the USB signal is active (YES in step C2), the system controller 116 instructs the recording medium I/F 114 to read image data from the recording medium 115. Then, the data storage part 116b instructs the external data I/F 129 to transmit the read image data to the data storage unit 40 for storage operation (step C4).

In the storage operation, if the occurrence of an error is notified from the data storage unit 40 to the external data I/F 129 (YES in step C5), the system controller 116 stores in the EEPROM 117 an image error flag indicating an error in completion of the storage of the image data and the storage error flag indicating that an error has occurred during the storage operation (steps C6 and C7). On the other hand, if the storage operation is completed normally (NO in step C5), the system controller 116 compares the stored data with the original data (step C8). As a result of the comparison, if any different is found (NO in step C9), the system controller 116 also stores in the EEPROM 117 the image error flag indicating an error in completion of the storage of the image data and the storage error flag indicating that an error has occurred during the storage operation (steps C6 and C7).

Even if the comparison shows that the image data is stored correctly (YES in step C9), the data control part 116a does not perform automatic erasing of the image data at this timing. After completion of steps C4 to C9 for all image data on the recording medium 115 (YES in step C10), the data control part 116a communicates with the data storage unit 40. The data storage unit 40 as the storage destination performs the finalization of the recording medium (step C11 in FIG. 13).

If the finalization is failed (NO in step C12), the data storage unit 40 notifies the camera 1 of the failure. Upon receipt of the notification, the system controller 116 controls the image processor 112, the on-screen circuit 107, and the TFT-LCD drive circuit 108 to display on the TFT panel 109 a message indicating a writing error to the recording medium (step C13). On the other hand, if the finalization is successful (Yes in step C12), the data control part 116a confirms at this timing whether an image storage error flag for each of the stored image data is held in the EEPROM 117 (step C14). As a result, if no image storage error flag is held and none of the printing program, the distribution program, the album registration, and the protection is set for the image data (YES in step C15), the data control part 116a performs automatic erasing of stored image data (step C16).

Then, the data control part 116a executes steps C14 to C16 for all image data on the recording medium 115. After completion of the steps C14 to C16 for all image data (YES in step C17), the system controller 116 checks whether any storage error flag is held in the EEPROM 117 (step C18). If any storage error flag is held (YES in step C18), the system controller 116 controls the image processor 112, the on-screen circuit 107, and the TFT-LCD drive circuit 108 to display a message indicating that an error has occurred during the storage operation (step C19).

Thus, at the time of automatically erasing stored image data, control is made in the camera 1 in consideration of not only the normal completion of the storage of each piece of image data, but also the normal completion of the finalization of the recording medium.

The above describes automatic erasing of image data from the recording medium 115 (on the side of the camera 1) after the completion of the storage of the image data into the data storage unit 40. However, since the camera 1 can be connected to various external devices by attaching it to the stand unit 22, the technique of the present invention can have a variety of applications other than the automatic erasing of stored data.

The following structures are derived from the embodiment described above:

1) A camera comprising:

a data communication part (external data I/F 129) for communicating with an external device to transmit image data to the external device;

a data storage part (data storage part 116b) for instructing the data communication part to transfer and store, into the external device, image data stored on a recording medium incorporated in or removably loaded into the camera; and

a data control part (data control part 116a) for performing control operations related to the image data stored on the recording medium,

wherein when erasing, from the recording medium, the image data transferred through the data storage part to the external device, the data control part performs control not to erase image data for which a predetermined setting is made.

2) The camera as set forth in 1), wherein when image data corresponds to at least one of image data programmed for printing, image data registered in a specific group, and image data programmed for distribution to a network, the data control part determines that the predetermined setting is made for the image data, and performs control not to erase the image data from the recording medium.

3) The camera as set forth in 2) further comprising a print instruction part (print instruction part c) for instructing the data communication part to transmit, to an external printer, only image data programmed to be printed from all image data stored on the recording medium so that the image data transmitted will be printed on the printer,

wherein after completion of storage into the external device through the data storage part and printing on the printer through the print instruction part, the data control part clears the printing program and erases the image data from the recording medium.

4) The camera as set forth in 2) further comprising a data distribution part (data distribution part 116d) for instructing the data communication part to transmit, to the network (network 71), image data stored on the recording medium and programmed for distribution as one of the predetermined settings so that the image data transmitted will be distributed to a remote device(s) (remote devices 72),

wherein after completion of storage into the external device through the data storage part and distribution to the remote device(s) through the data distribution part, the data control part clears the distribution program and erases the image data from the recording medium.

5) A camera system including a camera, a first external device (data storage unit 40) for storing image data transferred from the camera, and a second external device (printer 50) for printing an image(s) of image data transmitted from the camera, the camera comprising:

a data communication part (external data I/F 129) for communicating with the external devices to transmit image data to the external devices;

a data storage part (data storage part 116b) for instructing the data communication part to transfer and store, into the first external device, image data stored on a recording medium incorporated in or removably loaded into the camera;

a print instruction part (print instruction part 116c) for instructing the data communication part to transfer, to the second external device, image data programmed to be printed from all image data stored on the recording medium so that the image data transferred will be printed on the second external device; and

a data control part (data control part 116a) for clearing the printing program and erasing the image data from the recording medium after completion of storage into the first external device through the data storage part and printing on the second external device through the print instruction part.

It should be noted that the scope of the present invention includes such a structure that a software program for causing a system controller 116 (as a main CPU) to execute the above-mentioned functions is supplied so that the system controller 116 will operate according to the program supplied to implement the functions of the embodiment described above. In other words, since the software program itself implements the functions of the embodiment described above, the program itself can form an embodiment of the present invention.

The program can also be stored in any format on a recording medium other than the above-mentioned EEPROM, read from the recording medium, and executed by the system controller 116. Alternatively, the program can be stored on a recording medium removably loaded into the camera 1. As the recording medium, an optical recording medium such as a DVD, a magnetic recording medium such as an MD, a tape medium, a semiconductor memory such as an IC card, etc. can be used as well as a floppy disk (registered trademark) and a CD-ROM.

Further, a storage device such as a hard disk or RAM provided in a server system connected to a private communication network or the Internet can be used as the recording medium to provide the program to the camera 1 through the communication network. Even if the program cooperates with another application program to perform the functions of the aforementioned embodiment, such a program is, of course, included as an embodiment of the present invention.

Furthermore, part or all of the aforementioned functions executed by the system controller can be implemented via hardware. Note that the order of processing steps is not limited unless otherwise specified in the aforementioned embodiment.

While there has been shown and described what are considered to be a preferred embodiment of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A camera comprising:
a data communication part for communicating with an external device to transmit image data to the external device;
a data storage part for instructing the data communication part to transmit and store, into the external device, image data stored on a recording medium incorporated in or removably loaded into the camera; and
a data control part for performing control operations related to the image data stored on the recording medium,
wherein when erasing, from the recording medium, the image data transmitted through the data storage part to the external device, the data control part performs control not to erase image data for which a predetermined setting is made.

2. The camera according to claim 1, wherein
when image data corresponds to at least one of image data programmed for printing, image data registered in a specific group, and image data programmed for distribution to a network, the data control part determines that the predetermined setting is made for the image data, and performs control not to erase the image data from the recording medium.

3. The camera according to claim 1, wherein
the data control part erases, from the recording medium, image data transmitted to the external device through the data storage part after confirming that the transmitted image data has been stored in the external device.

4. The camera according to claim 2 further comprising
a print instruction part for instructing the data communication part to transmit, to an external printer, only image data programmed to be printed from all image data stored on the recording medium so that the image data transmitted will be printed on the printer,
wherein after completion of storage into the external device through the data storage part and printing on the printer through the print instruction part, the data control part cancels the printing program and erases the image data from the recording medium.

5. The camera according to claim 2 further comprising
a data distribution part for instructing the data communication part to transmit, to a network, image data stored on the recording medium and programmed for distribution as one of the predetermined settings so that the image data transmitted will be distributed to a remote device(s),
wherein after completion of storage into the external device through the data storage part and distribution to the remote device(s) through the data distribution part, the data control part cancels the distribution program and erases the image data from the recording medium.

6. The camera according to claim 1, wherein when a recording medium of the external device on which image data is to be stored requires finalization, the data control part erases the image data after confirming the completion of finalization in the external device.

7. A camera system including a camera, a first external device for storing image data transmitted from the camera, and a second external device for printing an image of image data transmitted from the camera, wherein the camera comprises
a data communication part for communicating with the external devices to transmit image data to the external devices,
a data storage part for instructing the data communication part to transmit and store, into the first external device, image data stored on a recording medium incorporated in or removably loaded into the camera,
a print instruction part for instructing the data communication part to transmit, to the second external device, image data programmed to be printed from all image data stored on the recording medium so that the image data transmitted will be printed on the second external device, and
a data control part for clearing the printing program and erasing the image data from the recording medium after completion of storage into the first external device through the data storage part and printing on the second external device through the print instruction part.

8. A camera control method for transmitting and storing image data into an external device from a camera through a data communication part,
wherein the control method is configured to instruct the data communication part to transmit and store, into the external device, image data stored on a recording medium incorporated in or removably loaded into the camera, so that, when erasing stored image data from the recording medium, image data corresponding to at least one of image data programmed for printing, image data programmed for distribution, and image data registered in a specific group is not erased from the recording medium even after being stored in the external device.

9. A computer-readable recording medium recording a program for causing a computer to execute a camera control method for transmitting and storing image data into an external device from a camera through a data communication part,
wherein the control method is configured to instruct the data communication part to transmit and store, into the external device, image data stored on a recording medium incorporated in or removably loaded into the camera, so that, when erasing stored image data from the recording medium, image data corresponding to at least one of image data programmed for printing, image data programmed for distribution, and image data registered in a specific group is not erased from the recording medium even after being stored in the external device.
